(19) United States
(12) Patent Application Publication
(10) Pub. No.: US 2019/0369819 A1
(43) Pub. Date: Dec. 5, 2019

(54) Graphical User Interface

(71) Applicant: GE Inspection Technologies, LP, Lewistown, PA (US)

(72) Inventors: Bright Tzeng, San Ramon, CA (US); Min Chang, San Ramon, CA (US); James Lee, San Ramon, CA (US)

(21) Appl. No.: 15/996,423

(22) Filed: Jun. 1, 2018

(51) Int. Cl. G06F 3/0482; G06F 3/0484; G06F 3/0481

(52) U.S. Cl. CPC G06F 3/0482; G06F 3/04817; G06F 3/04845

(57) ABSTRACT

The current subject matter provides an improved GUI that includes an improved navigation menu. The improved navigation menu can efficiently present a user with options for navigating the application and/or website, and provide an intuitive view of information available to the user. In one embodiment, the navigation menu can include a navigation icon that can be selected by the user. Upon selection of the navigation icon, a rotating menu showing entries corresponding to a first level of navigation options can be displayed about the menu icon. Upon receiving a user input the entries within the rotating menu can rotate automatically rotate until a desired entry is at a position adjacent to the mouse icon to be selectable by the user. Therefore, the navigation menu can reduce an amount of display space required to convey selectable options to a user, and/or improve efficiency of navigating applications and/or websites.

### BACKGROUND

A graphical user interface (GUI) can allow a user to interact with a computer application and/or website to control various aspects of the application and/or website. For example, the GUI can allow users to selectively access, visualize, and/or control various processes related to industrial operations such as liquefied natural gas (LNG) production. Some GUIs include navigation menus in the form of extended lists that enable a user to navigate applications and/or websites. Some navigation menus are hierarchically organized, allowing navigation through different levels of the menu structure. For example, selecting a given menu entry can expand the selected entry to show a second menu (e.g., a sub-menu) with options related to the selected entry. In some cases, entries within subsequent sub-menus can expand into new sub-menus, depending on a depth of navigation available within the application and/or website.

### SUMMARY

Systems, devices, non-transitory computer program products, and methods for generating an improved graphical user interface (GUI) are provided that include an improved navigation menu, which can efficiently present a user with options for navigating the application and/or website, and can provide an intuitive view of information available to the user. In one embodiment, a method is provided that includes receiving, by an input device, a first user input characterizing user selection of a first graphical object within a graphical user interface (GUI) display space. The method can also include rendering, by at least one data processor and within the GUI display space, a first rotating menu that can extend along a first curved path. The first rotating menu can have a first entry at a first position and a second entry at a second position. The first and second entries can be positioned along the first curved path. The method can further include receiving, by the input device, a second user input at a third position located between the first entry and the second entry. The method can further include rotating, by the at least one data processor and based on the second user input, the first rotating menu such that the second entry rotates to the first position.

One or more of the following features can be included in any feasible combination. In some embodiments, the method can include receiving a third user input that can characterize user selection of the second entry, and rendering, within the GUI display space, a first linear menu that can extend along a first path that can intersect the first position. The linear menu can have a third entry at a fourth position. The method can further include receiving a fourth user input that can characterize user selection of the third entry, and rendering, within the GUI display space, a second rotating menu that can extend along a second curved path. The second rotating menu can have a fourth entry.

In some embodiments, the method can include receiving a fifth user input at a fifth position, between third entry and the fourth entry. The method can further include rotating, based on the fifth user input, the second rotating menu such that the fourth entry is at the third position.

In some embodiments, the first path can intersect the first position and a center point of the first graphical object.

In some embodiments, a first radius of curvature of the first curved path can be less than a second radius of curvature of the second curved path.

In some embodiments, the first curved path and the second curved path can be parallel.

In some embodiments, the first curved path and the second curved path can form concentric circles.

In some embodiments, the GUI display space can be displayed on a display of a computing device. The computing device can include the input device, the display, and the at least one data processor.

In another aspect, a system is provided having at least one data processor and memory coupled to the processor. The memory can store executable instructions, which, when executed by the at least one data processor, implement operations which can include receiving, by an input device, a first user input characterizing user selection of a first graphical object within a graphical user interface (GUI) display space. The operations can also include rendering, by the at least one data processor and within the GUI display space, a first rotating menu that can extend along a first curved path. The first rotating menu can have a first entry at a first position and a second entry at a second position. The first and second entries can be positioned along the first curved path. The operations can further include receiving, by the input device, a second user input at a third position located between the first entry and the second entry. The operations can further include rotating, by the at least one data processor and based on the second user input, the first rotating menu such that the second entry rotates to the first position.

One or more of the following features can be included in any feasible combination. In some embodiments, the operations can include receiving a third user input that can characterize user selection of the second entry, and rendering, within the GUI display space, a first linear menu that can extend along a first path that can intersect the first position. The linear menu can have a third entry at a fourth position. The operations can further include receiving a fourth user input that can characterize user selection of the third entry, and rendering, within the GUI display space, a second rotating menu that can extend along a second curved path. The second rotating menu can have a fourth entry.

In some embodiments, the operations can include receiving a fifth user input at a fifth position, between third entry and the fourth entry. The operations can further include rotating, based on the fifth user input, the second rotating menu such that the fourth entry is at the third position.

In some embodiments, the first path can intersect the first position and a center point of the first graphical object.

In some embodiments, a first radius of curvature of the first curved path can be less than a second radius of curvature of the second curved path.

In some embodiments, the first curved path and the second curved path can be parallel.

In some embodiments, the first curved path and the second curved path can form concentric circles.

In some embodiments, the GUI display space can be displayed on a display of a computing device. The computing device can include the input device, the display, and the at least one data processor.

In another aspect, a non-transitory computer program product is provided having computer readable instructions, which, when executed by at least one data processor forming part of at least one computing system, implement operations which can include receiving, by an input device, a first user input characterizing user selection of a first graphical object within a graphical user interface (GUI) display space. The operations can also include rendering, by the at least one data processor and within the GUI display space, a first rotating menu that can extend along a first curved path. The first rotating menu can have a first entry at a first position and a second entry at a second position. The first and second entries can be positioned along the first curved path. The operations can further include receiving, by the input device, a second user input at a third position located between the first entry and the second entry. The operations can further include rotating, by the at least one data processor and based on the second user input, the first rotating menu such that the second entry rotates to the first position.

One or more of the following features can be included in any feasible combination. In some embodiments, the operations can include receiving a third user input that can characterize user selection of the second entry, and rendering, within the GUI display space, a first linear menu that can extend along a first path that can intersect the first position. The linear menu can have a third entry at a fourth position. The operations can further include receiving a fourth user input that can characterize user selection of the third entry, and rendering, within the GUI display space, a second rotating menu that can extend along a second curved path. The second rotating menu can have a fourth entry.

In some embodiments, the operations can include receiving a fifth user input at a fifth position, between third entry and the fourth entry. The operations can further include rotating, based on the fifth user input, the second rotating menu such that the fourth entry is at the third position.

In some embodiments, the first path can intersect the first position and a center point of the first graphical object.

In some embodiments, a first radius of curvature of the first curved path can be less than a second radius of curvature of the second curved path.

In some embodiments, the first curved path and the second curved path can be parallel.

In some embodiments, the first curved path and the second curved path can form concentric circles.

In some embodiments, the GUI display space can be displayed on a display of the computing device. The computing device can include the input device, the display, and the at least one data processor.

### DESCRIPTION OF DRAWINGS

These and other features will be more readily understood from the following detailed description taken in conjunction with the accompanying drawings, in which:

FIG. 1 is a flow diagram illustrating an exemplary method of rendering a navigation menu within graphical user interface (GUI) displace space;

FIG. 2 is an exemplary view of an example GUI that can be rendered on a user device, the GUI having a menu icon for navigation menu;

FIG. 3 is another view of the exemplary GUI that shows an rotating menu of the navigation menu;

FIG. 4 another view of the exemplary GUI that shows a linear menu extending from an entry within the rotating menu of FIG. 3;

FIG. 5 is another view of the exemplary GUI that shows the rotating menu, shown in FIG. 3, in a rotated position;

FIG. 6 is another exemplary view of the GUI, shown in FIG. 5, with the navigation menu having another menu;

FIG. 7 illustrates an exemplary system block diagram of an embodiment of a user device 700 configured to generate the GUI and perform the methods described herein;

FIG. 8 shows a flow chart illustrating an exemplary method of operation of the user device; and

FIG. 9 is an exemplary view of another GUI that can be rendered on a user device, the GUI having a menu icon for navigation menu.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings.

A graphical user interface (GUI) can allow a user to interact with a computer application and/or website to control various aspects of the application and/or website. For example, the GUI can allow users to selectively access, visualize, and/or control various processes related to industrial operations, although some implementations of the current subject matter are not limited to industrial operations. Some GUIs include navigation menus in the form of extended lists that enable a user navigating applications and/or websites. Navigating such extended lists can require users to move an input across a large region of the GUI (e.g., move a mouse, finger, etc.) across the width and the height of the GUI), in order to select a particular menu sub-entry. Due to the multitude of options available, the GUI may not be able to display all menu sub-entries, which can be inefficient and/or ineffective for the user, and can result in a poor user experience.

Accordingly, an improved GUI is provided that can include an improved navigation menu. The improved navigation menu can efficiently present a user with options for navigating the application and/or website, and can provide an intuitive view of information available to the user. For example, the improved GUI can include rotating components that rotate based on a user input, thereby limiting and/or reducing the distance a user input would need to travel over the GUI in order to select a menu subentry. The improved GUI can present menu entries along an arc, (e.g., a concentric circle) in order to present the menu entries in an efficient manner. In some embodiments, selected sub-entries can generate new lists of menu entries provided along another arc, such that the navigation menu expands as the user selects subsequent sub-entries for navigating the application and/or website. By providing an expandable navigation menu, and automatically rotating entries within rotating menus, desired entries can be presented to the user with minimal input from the user, thereby improving efficiency of menu navigation. Therefore, the improved navigation menu can reduce an amount of display space required to convey selectable options to a user, and/or improve efficiency of navigating applications and/or websites, thereby providing improved user interfaces. Reducing the amount of display space required to convey user selectable options to a user can be important, for example, for systems with small display sizes, such as mobile or tablet device, and also for applications that utilize portions of the GUI display space for other functionalities.

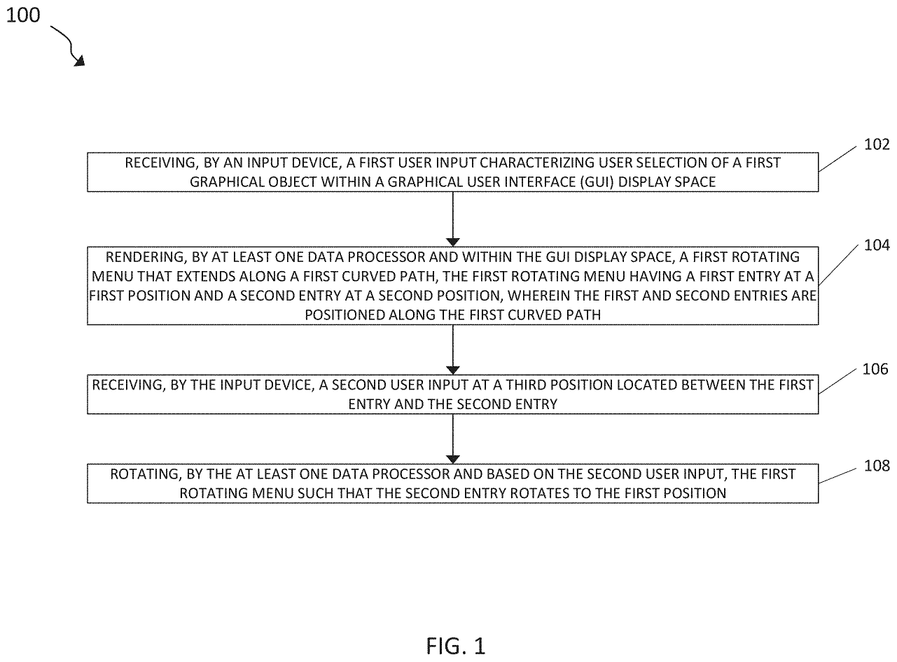

FIG. 1 shows a flow diagram illustrating an example method 100 of rendering a navigation menu within graphical user interface (GUI) displace space. The navigation menu can enable a user to efficiently navigate through an application and/or website by reducing motion required for users to select various options, or entries.

At step 102, a first user input can be received by an input device. The first user input can characterize user selection of a first graphical object within a graphical user interface (GUI) display space. In some embodiments, the GUI can be rendered by a processor coupled to an output device such as, e.g., a display, of a user device. In some embodiments, the user device can be a computer (e.g., laptop or a desktop), a handheld device (e.g., a tablet, mobile phone, etc.), and/or a wearable device (e.g., a headset). As an example, the user can select a menu icon using an input device of the user device. In some embodiments, the input device can be, or can include, a keyboard, a pointing device (e.g., a mouse, trackball, stylus, etc.), a gesture recognition device (e.g., a camera), a microphone, etc., by which the user can provide input to the computer. In some embodiments, the output device can be in interactive display such as, e.g., a touchscreen display. In that case, the output device can also function as the input device 608. The rendered GUI can be displayed on the display.

At step 104, a first rotating menu can be rendered within the GUI display space by at least one data processor. For example, a data processor of the user device can render the first rotating menu. The first rotating menu can extend along a first curved path. The first rotating menu can have a first entry at a first position and a second entry at a second position. The first and second entries can be positioned along the curved path. The first rotating menu can have a number of entries that can be positioned along the first curved path. The entries (e.g., the first entry and the second entry) can correspond to a first level of user selectable options for navigating an application or website. In some embodiments, the first rotating menu can extend about an outer boundary of the first graphical object. As another example, entries provided within the first rotating menu can be positioned along paths that extend radially outward from a center point of the first graphical object.

At step 106, a second user input can be received (e.g., by the processor and/or by the input device). The second user input can be at, or indicate, a third position on the GUI, between the first entry and the second entry. For example, the second user input can be, or correspond to, a position of a pointing device, or icon, rendered within the GUI display space. The third position can be located within a region defined by the first position and the second position. For example, the region may be defined as an arc segment extending from 33% of the distance from the first position to the second position.

At step 108, the first rotating menu can be rotated, based on the second user input, such that the second entry rotates to the first position. For example, the data processor of the user device can render an animation illustrating the entries within the first rotating menu rotating such that the second entry rotates toward the first position. In some embodiments, entries within the first rotating menu can automatically rotate about the center point of the first graphical object, based on the second user input. In some implementations, the rotating of the menu occurs until the second entry is located at the first position. In some implementations, the rotating occurs continuously until the user provides additional user input, for example, by moving a cursor away from the first region or to the first position. By automatically rotating the first rotating menu, entries within the first rotating menu can be presented to the user with minimal input from the user, thereby improving efficiency of menu navigation.

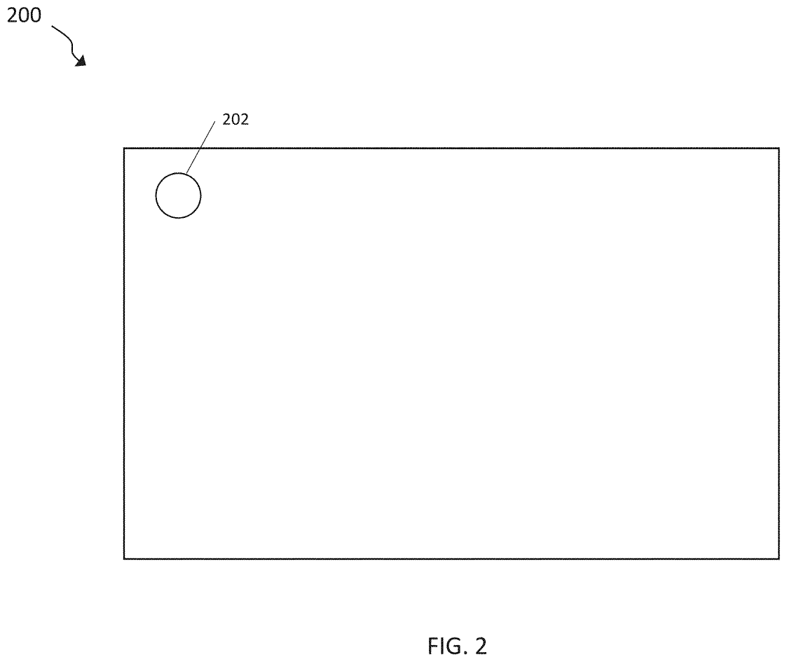

FIG. 2 shows an exemplary view 200 of an example GUI that can be rendered at a user device based on the method 100 described herein. As shown in FIG. 2, the GUI can include a user selectable menu icon 202. The GUI can also include any other icons, text, and/or graphical object corresponding to the function of the GUI. A user can select the menu icon 202 using an input device such as, e.g., a keyboard, a pointing device (e.g., a mouse, trackball, stylus, etc.), finger, a gesture recognition device (e.g., a camera). Selection can include hovering an input (e.g., a mouse cursor) over the menu icon 202 or selecting the menu icon (e.g., via a mouse button or gesture input).

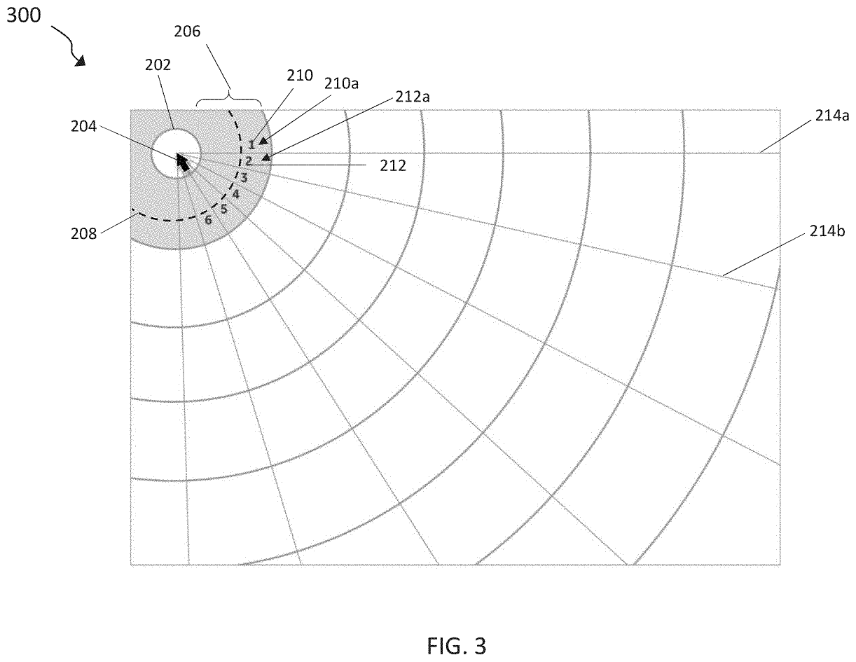

FIG. 3 shows a view 300 of the example GUI in which the user has selected the menu icon using a mouse icon 204. Upon selection of the menu icon 202, a rotating menu 206 can be rendered adjacent to, and/or about, the menu icon 202. For example, a data processor of a user device can render an animation showing the rotating menu 206 extending radially outward from the menu icon 202. The rotating menu 206 can extend along a curved path 208 about the menu icon 202. In some implementations, this first rotating menu 206 may be referred to as a main menu. The rotating menu 206 can have user selectable entries (e.g., a first 210 and a second entry 212) positioned along the curved path 208. The first entry 210 can be at a first position 210a, and the second entry can be at a second position 212a. As another example, entries (e.g., the first entry 210 and the second entry 212) provided within the rotating menu 206 can be positioned along paths (e.g., first and second paths 214a, 214b) that extend radially outward from a center point of the menu icon 202. In some embodiments, the entries (e.g., the first entry 210 and the second entry 212) can be text entries. The text entries can extend parallel to the paths (e.g., first and second paths 214a, 214b) that extend radially outward from the center point of the menu icon. The entries (e.g., the first entry 210 and the second entry 212) can correspond to a first level of user selectable option for navigating an application or website.

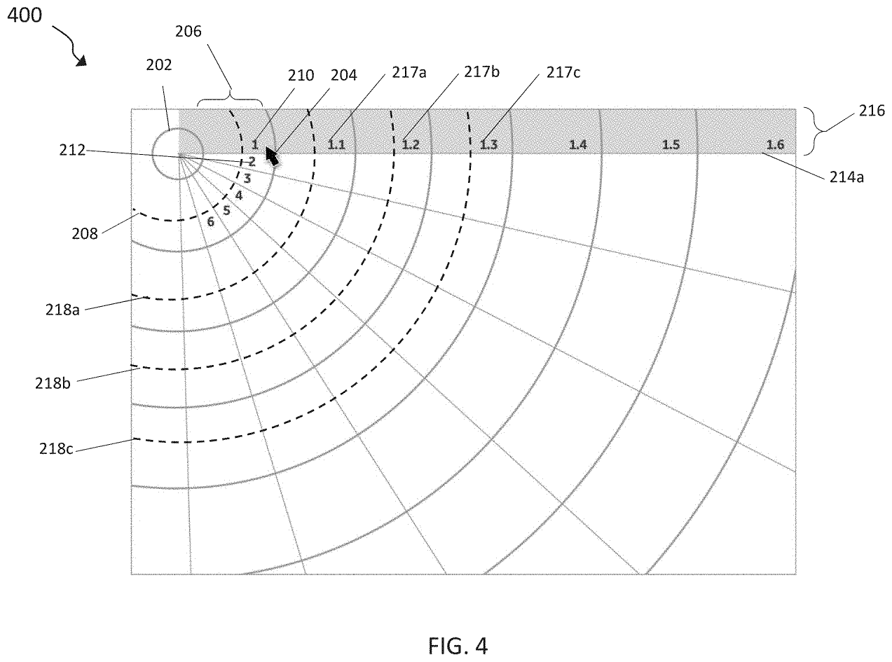

In some embodiments, a user can select an entry within the rotating menu 206, and a linear menu, extending from the selected entry, can be rendered within the GUI. FIG. 4 shows a view 400 of the GUI in which the user has selected the first entry 210. In some embodiments, selecting the desired entry can involve positioning the mouse icon 204 over the desire entry and/or performing another action such as, e.g., clicking, tapping, using a voice command, etc. In response to the selected entry (e.g., the first entry 210), a linear menu 216 can be rendered along the first path 214a. The linear menu 216 can be a submenu corresponding to the selected first entry 210. The linear menu 216 can include a plurality of entries (e.g., entries 217a, 217b, 217c) positioned along the first path 214a. The entries (e.g., entries 217a, 217b, 217c) within the linear menu 216 can correspond to a second level of user selectable option for navigating an application or website. For example, the entries (e.g., entries 217a, 217b, 217c) within the linear menu 216 can provide navigation options that specifically correspond to, and/or are based on, the first entry 210 selected by the user.

In some embodiments, the entries (e.g., entries 217a, 217b, 217c) within the linear menu 216 can include rotating submenus that extend along curved paths 218a, 218b, 218c. The submenus can provide navigation options that specifically correspond to, and/or are based on the entries (e.g., entries 217a, 217b, 217c) within the linear menu 216. In some embodiment the curved paths 208, 218a, 218b, 218c can form concentric circles with center points at the center point of the menu icon 202.

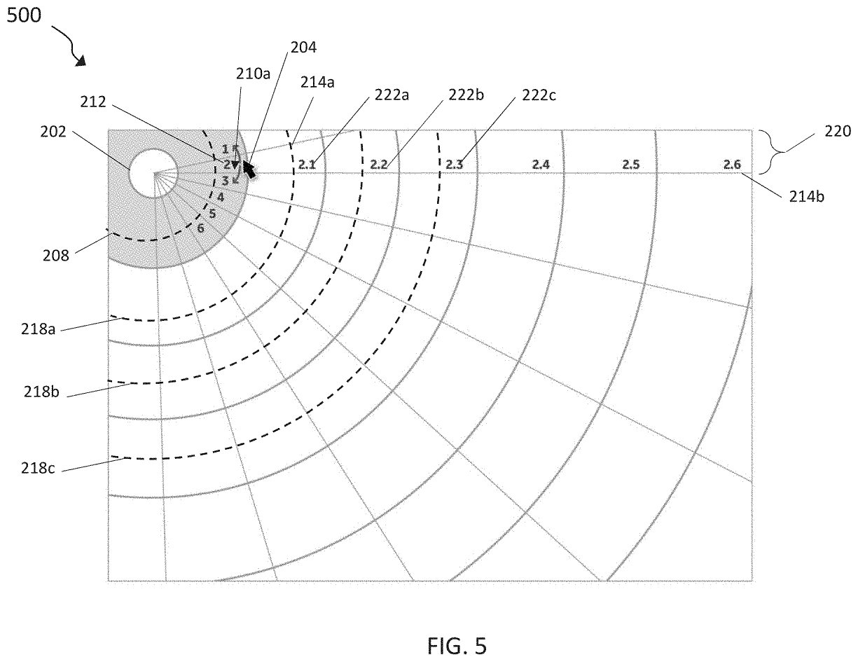

Rather than selecting the first entry 210 within the rotating menu 206, the user can select another entry (e.g., the second entry 212). In some embodiments, the user can position the mouse icon 204 at a point between the first and second entries 210, 212, and the rotating menu 206 can automatically rotate such that the second entry 212 rotates to the first position 210a, as illustrated in the view 500, shown in FIG. 5. The rotation can occur in a counter-clockwise direction. For example, the data processor of the user device can render an animation illustrating the entries within the rotating menu 206 rotating such that the second entry 212 rotates to the first position 210a. In some embodiments, a rate of rotation of the rotating menu 206 can be based on a position of the mouse icon 204. For example, if the mouse icon is closer to the second entry 212, the rotating menu 206 can rotate quickly. Alternatively, if the mouse icon 204 is closer to the first entry 210, the rotating menu 206 can rotate more slowly. As another example, the user can select, or identify, the rotating menu 206, and enter another input such as, e.g., rotating a scroll wheel, performing an action (e.g., swiping) on a touch display, etc., thereby causing the rotating menu 206 to rotate. In some embodiments, the user can select, or identify, the rotating menu 206, by positioning the mouse icon 204 at a point within the rotating menu 206. Rotation can occur in a clockwise direction in response to the user providing input at a location above the first position 210a.

In some embodiments, a rotation mode can be activated by a user input (e.g., a mouse click, a button press on a keyboard, an input on a touch display, using a voice command, etc.). When in the rotation mode, the rotating menu 206 can rotate to allow the user to select an entry at position 210a. During rotation, each entry (e.g., entry 212) can pass through position 210a, such that the user can select the desired entry (e.g., entry 212). In some embodiments, a user input can be used to deactivate the rotation mode when the desired entry (e.g., entry 212) is at the position 210a. For example, the user input can be, e.g., a mouse click, a button press on a keyboard, an input on a touch display, using a voice command, etc. By automatically rotating the rotating menu 206, entries (e.g., entries 210, 212) within the rotating menu 206 can be presented to the user with minimal input from the user, thereby improving efficiency of menu navigation.

Using the mouse icon 204, or another input method, the user can select the second entry 212. In response to the selection, a linear menu 220 can be rendered along the second path 214b. The linear menu 220 can be a submenu corresponding to the selected second entry 212. The linear menu 220 can include a plurality of entries (e.g., entries 222a, 222b, 222c) positioned along the second path 214b. The entries (e.g., entries 222a, 222b, 222c) within the linear menu 220 can correspond to a second level of user selectable option for navigating an application or website. For example, the entries (e.g., entries 222a, 222b, 222c) within the linear menu 220 can provide navigation options that specifically correspond to, and/or are based on, the second entry 212 selected by the user. The entries (e.g., entries 222a, 222b, 222c) within the linear menu 220 can include rotating submenus that extend along curved paths 218a, 218b, 218c. The submenus can provide navigation options that specifically correspond to, and/or are based on the entries (e.g., entries 222a, 222b, 222c) within the linear menu 220.

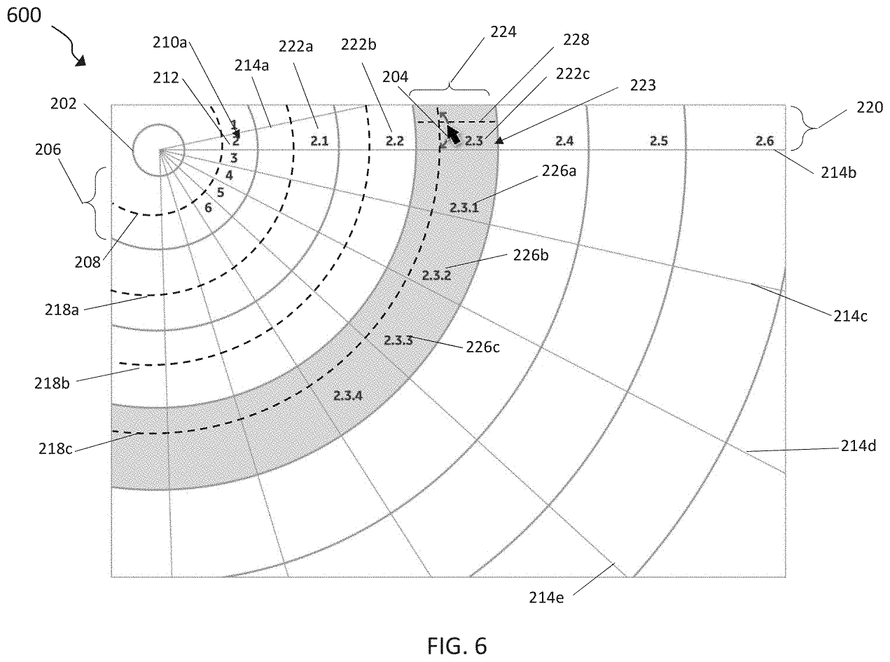

As described herein, the user can select an entry (e.g., entries 222a, 222b, 222c) within the linear menu 220. In some embodiments, selecting the desired entry can involve positioning the mouse icon 204 over the desired entry and/or performing another action such as, e.g., clicking, tapping, using a voice command, etc. FIG. 6 shows a view 600 of the GUI in which the user has selected an entry (e.g., entry 222c) within the linear menu 220. After the entry 222c is selected, a rotating menu 224 can be rendered. The rotating menu 224 can extend from the entry 222c, at position 223, along the path 218c. The rotating menu 224 can include entries specifically corresponding to, and/or are based on the entry 222c within the linear menu 220. Entries (e.g., the entries 226a, 226b, 226c) provided within the rotating menu 224 can be positioned along paths (e.g., paths 214c, 214d, 214e) that extend radially outward from a center point of the menu icon 202. In some embodiments, the entries (e.g., the entries 226a, 226b, 226c) can be text entries. The text entries can extend parallel to the paths (e.g., paths 214c, 214d, 214e) that extend radially outward from the center point of the menu icon. The entries (e.g., entries 226a, 226b, 226c) can correspond to a third level of user selectable option for navigating an application or website.

To select an entry within the rotating menu 224, the user can position the mouse icon 204 at a point between the entries 222c, 226a, and the rotating menu 206 can rotate (e.g., in a counterclockwise direction) automatically. As another example, the user can position the mouse icon 204 at a point adjacent to (e.g., above or below) a predetermined position 228, adjacent to the entry 222c. The rotating menu 224 can rotate in response the position of the mouse icon 204 relative to the position 228. For example, if the mouse icon 204 is below the position 228, the rotating menu 224 can rotate in a counterclockwise direction. Alternatively, the mouse icon is positioned above the position 228, the rotating menu 228 can rotate in a clockwise direction. In some embodiments, a rate of rotation of the rotating menu 224 can be determine based on a distance between the mouse icon 204 and the position 228. For example, if the mouse icon 204 is position close to the position 228, the rotating menu 224 can rotate slowly. If the mouse icon 204 is positioned close to the position 228, the rotating menu can rotate quickly.

In some embodiments, a rotation mode can be activated by a user input (e.g., a mouse click, a button press on a keyboard, an input on a touch display, using a voice command, etc.). When the rotation mode is active, the rotating menu 224 can rotate to allow the user to select an entry at position 223. During rotation, each entry (e.g., entries 226a, 226b, 226c) can pass through point 223, such that the user can select the desired entry (e.g., one of the entries 226a, 226b, 226c). In some embodiments, a user input can be used to deactivate the rotation mode when the desire entry (e.g., one of the entries 226a, 226b, 226c) is at the position 223. For example, the user input can be, e.g., a mouse click, a button press on a keyboard, an input on a touch display, using a voice command, etc.). By automatically rotating the rotating menu 206, entries (e.g., entries 210, 212) within the rotating menu 206 can be presented to the user with minimal input from the user, thereby improving efficiency of menu navigation.

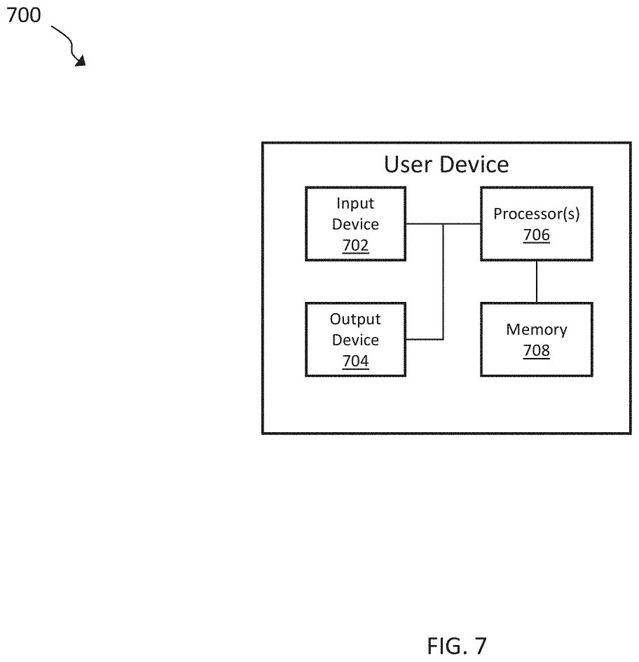

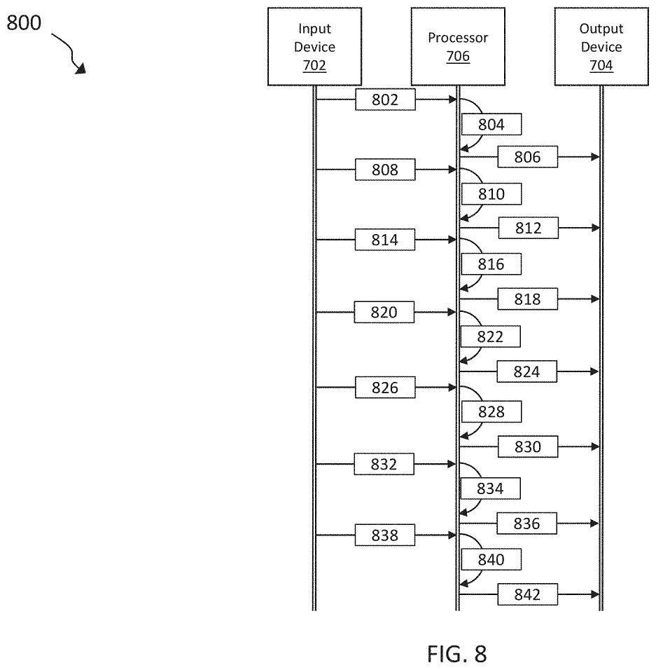

FIG. 7 illustrates an exemplary system block diagram of an embodiment of a user device 700 configured to generate the GUI and perform the methods described herein. In some embodiments, the user device 700 can be a computer (e.g., laptop or a desktop), a handheld device (e.g., a tablet, mobile phone, etc.), and/or a wearable device (e.g., a headset). As shown in FIG. 8, the user device 700 can include an input device 702, an output device 704, memory 708, at least one data processor 706, and/or other circuitry configured facilitate operation as described herein. As an example, the input device 702 can be, or can include, a keyboard, a pointing device (e.g., a mouse, trackball, stylus, etc.), a gesture recognition device (e.g., a camera), a microphone, etc., by which the user can provide input to the user device 700 (e.g., the processor 708). As another example, the output device 704 can be, or can include, a display device such as, e.g., a CRT (cathode ray tube), LCD (liquid crystal display) monitor, and/or LED (light-emitting diode) display. In some embodiments, the output device 704 can be in interactive display such as, e.g., a touchscreen display. In that case, the output device 704 can also function as the input device 702.

FIG. 8 shows a flow chart 800 illustrating an exemplary method of operation of the user device 700. At step 802, a user can provide a first user input via the input device 702, and the input device 702 can provide the first user input to the processor 706. The first user input can characterize user selection of a menu icon (e.g., menu icon 204) within a GUI display space on the output device 704.

At step 804, the processor 706 can process the user input and render a rotating menu (e.g., rotating menu 206). Referring to the views 200-600, the processor 706 render an animation showing the rotating menu 206, including entries (e.g., first and second entries 210, 212) extending radially outward from the menu icon 202. The rotating menu 206 can extend along the curved path 208 about the menu icon 202. The rotating menu 206 can have user selectable entries (e.g., first and second entries 210, 212) positioned along the curved path 208. The entries (e.g., entries 210, 212,) within the rotating menu 206 can correspond to a first level of user selectable option for navigating an application or website. In some embodiments, the processor 706 can populate the rotating menu 206 with entries based on predetermined instructions stored in memory. For example, the instructions can provide a list of text entries to provide in the rotating menu 206.

At step 806, the processor 706 can provide data characterizing the rendered GUI to the output device 704. The output device 704 can display the GUI, including the menu icon 204 and the rotating menu 206.

At step 808, the user can provide another user input via the input device 702, and the input device 702 can provide the user input to the processor 706. The user input can characterize user selection, or identification, of the rotating menu 206. For example, the user input can activate a rotation mode of the GUI such that the rotating menu 206 can be rotated. In some embodiments, the rotation mode can be activated by, e.g., a mouse click, positioning of the mouse icon 204 over a portion of the rotating menu 206, a button press on a keyboard, an input on a touch display, a voice command, and the like. When in the rotation mode, the rotating menu 206 can rotate to allow the user to select an entry at position 210a.

At step 810, the processor 706 can process the user input. For example, in response to the user input, the processor 706 can enable, or activate, the rotation mode, and render an animation illustrating rotation of the rotating menu 206 such that a desired entry (e.g., entry 212) is at a position (e.g., position 210a) to be selectable by the user. In some embodiments, the processor 706 can determine a rotation speed of the rotating menu 206 based on a position of the mouse icon 204, as described herein with regard to views 500, 600.

At step 812, the processor 706 can provide data characterizing the rendered animation to the output device 704. The output device 704 can display the animation within the GUI display space. In some embodiments, the processor 706 can provide data characterizing multiple rendered frames of the animation to the output device 704 such that the animation can be displayed on a display of the output device 704.

At step 814, the user can provide another user input via the input device 702, and the input device 702 can provide the user input to the processor 706. The user input can be a command to deactivate the rotation mode when the desired entry (e.g., entry 212) is at the position 210a. For example, the user input can be, e.g., a mouse click, a button press on a keyboard, an input on a touch display, using a voice command, etc. By automatically rotating the rotating menu 206, entries (e.g., entries 210, 212) within the rotating menu 206 can be presented to the user with minimal input from the user, thereby improving efficiency of menu navigation.

At step 816, the processor 706 can process the user input. For example, the processor 706 can deactivate the rotation mode and render a view of the GUI in which the desired entry (e.g., entry 212) is at a position (e.g., position 210a) to be selectable by the user.

At step 818, the processor 706 can provide data characterizing the rendered view of the GUI to the output device 704. The output device 704 can display the GUI, including the rotated rotating menu 206.

At step 820, the user can provide another user input via the input device 702, and the input device 702 can provide the user input to the processor 706. The input can characterize a user selection of the desired entry (e.g., entry 212) within the rotating menu 206.

At step 822, the processor 706 can process the user input. For example, the processor 706 can identify the selected entry, generate a linear menu based on the selected entry, and render a view (e.g., view 600) of the GUI including the linear menu (e.g., linear menu 220) extending from the selected entry. The linear menu 220 can be rendered along the second path 214b. The linear menu 220 can be a submenu corresponding to the selected second entry 212. The linear menu 220 can include a plurality of entries (e.g., entries 222a, 222b, 222c) positioned along the second path 214b. The entries (e.g., entries 222a, 222b, 222c) within the linear menu 220 can correspond to a second level of user selectable option for navigating an application or website.

At step 824, the processor 706 can provide data characterizing the rendered view (e.g., view 600) of the GUI. The output device 704 can display the GUI, including the linear menu 220.

At step 826, the user can provide another user input via the input device 702, and the input device 702 can provide the user input to the processor 706. The user input can characterize user selection an entry (e.g., entry 222c) from within the linear menu 220.

At step 828, the processor 706 can process the user input and render a rotating menu (e.g., rotating menu 824). Referring to the views 200-600, the processor 706 can render an animation showing the rotating menu 224, expanding from the entry 222c, along the curved path 218c. The rotating menu 224 can include including entries (e.g., 226a, 226b, 226c) that can be positioned along paths (e.g., paths 214c, 214d, 214e) that extend radially outward from a center point of the menu icon 202. In some embodiments, the entries (e.g., the entries 226a, 226b, 226c) can be text entries. The text entries can extend parallel to the paths (e.g., paths 214c, 214d, 214e) that extend radially outward from the center point of the menu icon. The entries (e.g., entries 226a, 226b, 226c) can correspond to a third level of user selectable option for navigating an application or website. In some embodiments, the processor 706 can populate the rotating menu 224 with entries based on predetermined instructions stored in memory. For example, the instructions can provide a list of text entries to provide in the rotating menu 224.

At step 830, the processor 706 can provide data characterizing the rendered animation to the output device 704. The output device 704 can display the animation within the GUI display space. In some embodiments, the processor 706 can provide data characterizing multiple rendered frames of the animation to the output device 704 such that the animation can be displayed on the display of the output device 704.

At step 832, the user can provide another user input via the input device 702, and the input device 702 can provide the user input to the processor 706. The user input can characterize user selection, or identification, of the rotating menu 224. For example, the user input can activate a rotation mode of the GUI such that the rotating menu 224 can be rotated. In some embodiments, the rotation mode can be activated by, e.g., a mouse click, positioning of the mouse icon 204 over a portion of the rotating menu 224, a button press on a keyboard, an input on a touch display, a voice command, and the like. When in the rotation mode, the rotating menu 206 can rotate to allow the user to select an entry at position 223.

At step 834, the processor 706 can process the user input. For example, in response to the user input, the processor 706 can enable, or activate, the rotation mode, and render an animation illustrating rotation of the rotating menu 206 such that a desired entry is at a position (e.g., position 223) to be selectable by the user. In some embodiments, the processor 706 can determine a rotation speed of the rotating menu 224 based on a position of the mouse icon 204, as described herein with regard to views 500, 600.

At step 836, the processor 706 can provide data characterizing the rendered animation to the output device 704. The output device 704 can display the animation within the GUI display space. In some embodiments, the processor 706 can provide data characterizing multiple rendered frames of the animation to the output device 704 such that the animation can be displayed on a display of the output device 704. By automatically rotating the rotating menu 224, entries (e.g., entries 210, 212) within the rotating menu 206 can be presented to the user with minimal input from the user, thereby improving efficiency of menu navigation.

At step 838, the user can provide another user input via the input device 702, and the input device 702 can provide the user input to the processor 706. The user input can be a command to deactivate the rotation mode when the desired entry (e.g., entry 226c) is at the position 223. For example, the user input can be, e.g., a mouse click, a button press on a keyboard, an input on a touch display, using a voice command, etc.

At step 840, the processor 706 can process the user input. For example, the processor 706 can deactivate the rotation mode and render a view of the GUI in which the desired entry (e.g., entry 226c) is at a position (e.g., position 223) to be selectable by the user.

At step 842, the processor 706 can provide data characterizing the rendered view of the GUI to the output device 704. The output device 704 can display the GUI, including the rotated rotating menu 224.

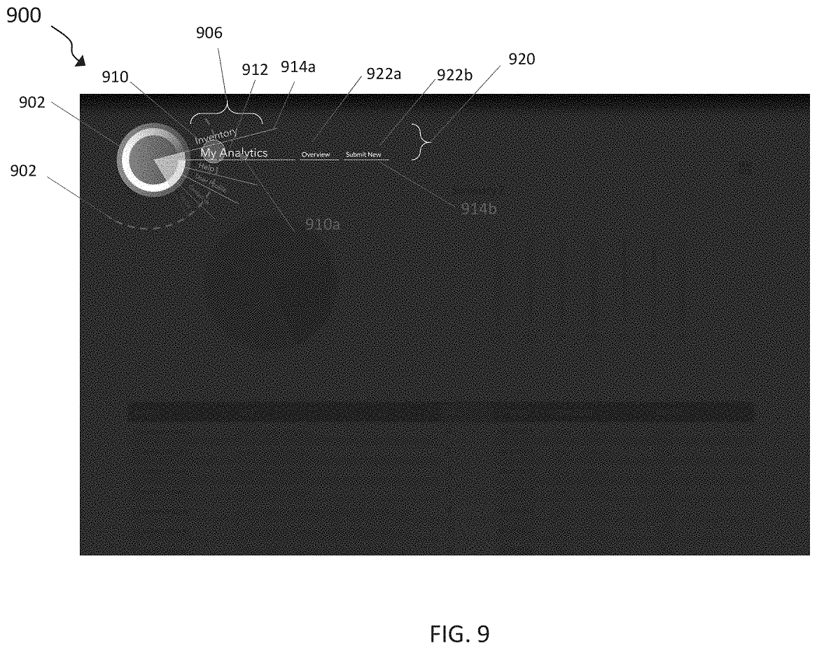

FIG. 9 shows a view 900 of an example GUI that can be similar to the view 600 shown in FIG. 6. In the illustrated example, the GUI includes a menu icon 902 and a rotating menu 906 extending along a curved path 908. The menu icon 902 and the rotating menu 906 can generally be similar to the menu icon 202 and the rotating menu 206. As shown in FIG. 9, the user has selected the menu icon 902, and the rotating menu 906 has been rendered adjacent to, and/or about, the menu icon 902. The rotating menu 906 can have user selectable entries (e.g., a first 910 and a second entry 912) positioned along the curved path 908. The first and second entries 910, 912 can be positioned along paths (e.g., first and second paths 914a, 914b) that extend radially outward from a center point of the menu icon 902.

In some embodiments, the user can position a mouse icon at a point between the first and second entries 910, 912, and the rotating menu 906 can automatically rotate such that the second entry 912 rotates to a first position 910a, as illustrated in the view 900, shown in FIG. 9. Using the mouse icon, or another input method, the user can select the second entry 912. In response to the selection, a linear menu 920 can be rendered along the second path 914b. The linear menu 920 can be a submenu corresponding to the selected second entry 912. The linear menu 920 can include a plurality of entries (e.g., entries 922a, 922b) positioned along the second path 914b. The entries (e.g., entries 922a, 922b) within the linear menu 920 can correspond to a second level of user selectable option for navigating an application or website. For example, the entries (e.g., entries 922a, 922b) within the linear menu 920 can provide navigation options that specifically correspond to, and/or are based on, the second entry 912 selected by the user. The entries (e.g., entries 922a, 922b) within the linear menu 920 can include rotating submenus that extend along curved paths (e.g., curved paths similar to curved paths 218a, 218b, 218c). The submenus can provide navigation options that specifically correspond to, and/or are based on the entries (e.g., entries 922a, 922b) within the linear menu 920.

Some traditional GUIs provide options for navigating applications and/or websites in the form of extended lists. Due to the multitude of options available, navigating such extended lists can be inefficient, and result in a poor user experience. In some cases, due to limited display space, accessing desirable information related to a data set may require several user inputs at various locations within the GUI. By providing an expandable navigation menu, and automatically rotating entries within rotating menus, display space can be used efficiently, desired entries can be presented to the user with minimal input from the user, thereby improving efficiency of menu navigation. The GUIs, including the navigation menu, provide a specific improvement in the capabilities of computing device such as, e.g., laptops, desktops, tablets, mobile phones, headset displays, and the like.

Although some example implementations are described above, other implementations are possible. For example, paths (e.g., paths 208, 218a, 218b, 218c) along which the rotating menus extend may not be parallel, or form concentric circles. As another example, the rotating menu (e.g., rotating menu 206) may replace the menu icon (e.g., menu icon 202) upon selection of the menu icon 202.

Exemplary technical effects of the subject matter described herein can include the ability efficiently provide a user with options for navigating an application and/or website by automatically rotating entries within a menu such that a desired entry is selectable by the user. By providing an expandable navigation menu, and automatically rotating entries within rotating menus, display space can be used efficiently, desired entries can be presented to the user with minimal input from the user, thereby improving efficiency of menu navigation.

One skilled in the art will appreciate further features and advantages of the subject matter described herein based on the above-described embodiments. Accordingly, the present application is not to be limited specifically by what has been particularly shown and described. All publications and references cited herein are expressly incorporated herein by reference in their entirety.

Other embodiments are within the scope and spirit of the disclosed subject matter. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method, comprising:
receiving, by an input device, a first user input characterizing user selection of a first graphical object within a graphical user interface (GUI) display space;
rendering, by at least one data processor and within the GUI display space, a first rotating menu that extends along a first curved path, the first rotating menu having a first entry at a first position and a second entry at a second position, wherein the first and second entries are positioned along the first curved path;
receiving, by the input device, a second user input at a third position located between the first entry and the second entry; and
rotating, by the at least one data processor and based on the second user input, the first rotating menu such that the second entry rotates to the first position.

2. The method of claim 1, further comprising
receiving a third user input characterizing user selection of the second entry;
rendering, within the GUI display space, a first linear menu that extends along a first path that intersects the first position, the linear menu having a third entry at a fourth position;
receiving a fourth user input characterizing user selection of the third entry; and
rendering, within the GUI display space, a second rotating menu that extends along a second curved path, the second rotating menu having a fourth entry.

3. The method of claim 2, further comprising
receiving a fifth user input at a fifth position, between the third entry and the fourth entry; and
rotating, based on the fifth user input, the second rotating menu such that the fourth entry is at the third position.

4. The method of claim 2, wherein the first path intersects the first position and a center point of the first graphical object.

5. The method of claim 2, wherein a first radius of curvature of the first curved path is less than a second radius of curvature of the second curved path.

6. The method of claim 2, wherein the first curved path and the second curved path are parallel.

7. The method of claim 6, wherein the first curved path and the second curved path form concentric circles.

8. The method of claim 1, wherein the GUI display space is displayed on a display of a computing device, the computing device including the input device, the display, and the at least one data processor.

9. A system comprising:
at least one data processor and memory coupled to the processor, the memory storing executable instructions, which, when executed by the at least one data processor, implement operations comprising:
receiving, by an input device, a first user input characterizing user selection of a first graphical object within a graphical user interface (GUI) display space;
rendering, by the least one data processor and within the GUI display space, a first rotating menu that extends along a first curved path, the first rotating menu having a first entry at a first position and a second entry at a second position, wherein the first and second entries are positioned along the first curved path;
receiving, by the input device, a second user input at a third position located between the first entry and the second entry; and
rotating, by the at least one data processor and based on the second user input, the first rotating menu such that the second entry rotates to the first position.

10. The system of claim 25, further comprising
receiving a third user input characterizing user selection of the second entry;
rendering, within the GUI display space, a first linear menu that extends along a first path that intersects the first position, the linear menu having a third entry at a fourth position;
receiving a fourth user input characterizing user selection of the third entry; and
rendering, within the GUI display space, a second rotating menu that extends along a second curved path, the second rotating menu having a fourth entry.

11. The system of claim 10, further comprising
receiving a fifth user input at a fifth position, between the third entry and the fourth entry; and
rotating, based on the fifth user input, the second rotating menu such that the fourth entry is at the third position.

12. The system of claim 10, wherein the first path intersects the first position and a center point of the first graphical object.

13. The system of claim 10, wherein a first radius of curvature of the first curved path is less than a second radius of curvature of the second curved path.

14. The system of claim 10, wherein the first curved path and the second curved path are parallel.

15. The system of claim 14, wherein the first curved path and the second curved path form concentric circles.

16. The system of claim 25, wherein the GUI display space is displayed on a display of a computing device, the computing device including the input device, the display, and the at least one data processor.

17. A non-transitory computer program product comprising computer readable instructions, which, when executed by at least one data processor forming part of at least one computing system, implement operations comprising:
receiving, by an input device, a first user input characterizing user selection of a first graphical object within a graphical user interface (GUI) display space;
rendering, by the least one data processor and within the GUI display space, a first rotating menu that extends along a first curved path, the first rotating menu having a first entry at a first position and a second entry at a second position, wherein the first and second entries are positioned along the first curved path;
receiving, by the input device, a second user input at a third position located between the first entry and the second entry; and
rotating, by the at least one data processor and based on the second user input, the first rotating menu such that the second entry rotates to the first position.

18. The non-transitory computer program product of claim 17, further comprising
receiving a third user input characterizing user selection of the second entry;
rendering, within the GUI display space, a first linear menu that extends along a first path that intersects the first position, the linear menu having a third entry at a fourth position
receiving a fourth user input characterizing user selection of the third entry; and
rendering, within the GUI display space, a second rotating menu that extends along a second curved path, the second rotating menu having a fourth entry.

19. The non-transitory computer program product of claim 18, further comprising
receiving a fifth user input at a fifth position, between the third entry and the fourth entry; and
rotating, based on the fifth user input, the second rotating menu such that the fourth entry is at the third position.

20. The non-transitory computer program product of claim 18, wherein the first path intersects the first position and a center point of the first graphical object.

21. The non-transitory computer program product of claim 18, wherein a first radius of curvature of the first curved path is less than a second radius of curvature of the second curved path.

22. The non-transitory computer program product of claim 18, wherein the first curved path and the second curved path are parallel.

23. The non-transitory computer program product of claim 22, wherein the first curved path and the second curved path form concentric circles.

24. The non-transitory computer program product of claim 17, wherein the GUI display space is displayed on a display of the computing device, the computing device including the input device, the display, and the at least one data processor.
